(19) United States
(12) Patent Application Publication
(10) Pub. No.: US 2020/0101786 A1
(43) Pub. Date: Apr. 2, 2020

(54) BALLPOINT DRY-ERASE MARKER

(71) Applicant: International Business Machines Corporation, Armonk, NY (US)

(72) Inventor: Khoi-Nguyen D. Tran, Southbank (AU)

(21) Appl. No.: 16/147,911

(22) Filed: Oct. 1, 2018

(51) Int. Cl. B43K 7/01; B43K 7/03; B43K 7/10

(52) U.S. Cl. CPC B43K 7/01; B43K 7/10; B43K 7/03

(57) ABSTRACT

A dry-erase marker comprising a cylindrical housing configured to store an ink and a conic housing coupled to the cylindrical housing on a first end and having a socket on a second end. The dry-erase marker further comprising a marker head contained in the socket of the conic housing, where the marker head comprises a polymeric material and a surface topology. The conic housing is configured to transfer the ink from the cylindrical housing to the marker head, and the marker head is configured to transfer the ink to a dry-erase board by rotating in the socket.

### BACKGROUND

The present disclosure relates to writing instruments, and, more specifically, to dry-erase markers (e.g., whiteboard markers).

Whiteboards are surfaces for temporary writing and dry erasing of markings made by whiteboard markers. Whiteboards can also be referred to as marker boards, dry-erase boards, wipe boards, dry-wipe boards, pen-boards, and/or grease boards. Dry-erase markers are configured to deposit non-permanent ink on whiteboards. The non-permanent ink requires correct properties (e.g., viscosity, chemical reactivity, etc.) to adhere to the whiteboard while not permanently binding to, or being absorbed by, the whiteboard.

### SUMMARY

Aspects of the present disclosure are directed toward a dry-erase marker comprising a cylindrical housing configured to store an ink, a conic housing coupled to the cylindrical housing on a first end and having a socket on a second end, and a spherical marker head contained in the socket of the conic housing. The spherical marker head comprising a polymeric material. The spherical marker head further comprising a plurality of circular depressions distributed about a surface of the spherical marker head. The conic housing being configured to transfer the ink from the cylindrical housing to the spherical marker head, and the spherical marker head being configured to transfer the ink to a dry-erase board by rotating in the socket.

Other aspects of the present disclosure are directed toward a dry-erase marker comprising a cylindrical housing configured to store an ink, a conic housing coupled to the cylindrical housing on a first end and having a socket on a second end, and a spherical marker head contained in the socket of the conic housing. The spherical marker head comprising a polymeric material. The spherical marker head further comprising a plurality of microfibers distributed about a surface of the spherical marker head. The conic housing being configured to transfer the ink from the cylindrical housing to the spherical marker head, and the spherical marker head being configured to transfer the ink to a dry-erase board by rotating in the socket.

Other aspects of the present disclosure are directed toward a dry-erase marker comprising a cylindrical housing configured to store an ink, a conic housing coupled to the cylindrical housing on a first end and having a socket on a second end, and a spherical marker head contained in the socket of the conic housing. The spherical marker head comprising a polymeric material. The spherical marker head further comprising a plurality of continuous grooves distributed about a surface of the spherical marker head. The conic housing being configured to transfer the ink from the cylindrical housing to the spherical marker head, and the spherical marker head being configured to transfer the ink to a dry-erase board by rotating in the socket.

The present Summary is not intended to illustrate each aspect of, every implementation of, and/or every embodiment of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a cross-sectional side-view of an example dry-erase marker, according to embodiments of the present disclosure.

FIG. 2A illustrates a cross-sectional view of an example marker head, according to embodiments of the present disclosure.

FIG. 2B illustrates a cross-sectional view of an example magnetic marker head, according to embodiments of the present disclosure.

FIG. 2C illustrates a cross-sectional view of an example composite marker head, according to embodiments of the present disclosure.

FIG. 3A illustrates a cross-sectional exploded view of an example surface topology of a marker head having a plurality of depressions, according to embodiments of the present disclosure.

FIG. 3B illustrates a cross-sectional exploded view of an example surface topology of a marker head having a plurality of microfibers, according to embodiments of the present disclosure.

FIG. 3C illustrates a cross-sectional exploded view of an example surface topology of a marker head having a plurality of continuous grooves, according to embodiments of the present disclosure.

FIG. 4 illustrates a flowchart of an example method for fabricating a dry-erase marker, according to embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward writing instruments, and, more specifically, to dry-erase markers (e.g., whiteboard markers). Although the below discussion focuses on dry-erase markers, aspects of the present disclosure are also applicable to other writing instruments such as, but not limited to, pens, permanent markers, semi-permanent markers, paint markers, or other writing instruments configured to deposit a liquid ink or paint on a writing medium.

Whiteboards are useful in planning, teaching, brainstorming, and organizing in educational, business, sports, personal, and other settings. Some whiteboards contain a melamine-infused paper attached to a backing board (e.g., particle board, medium density fiberboard (MDF), etc.). Some whiteboards comprise painted steel panels, aluminum panels, or porcelain steel panels. The paint can include a colored base coat and a clear performance coating that can be applied and air cured, electron-beam cured, ultra-violet (UV) cured, chemically cured, heat cured, or cured by a different mechanism. Advantageously, magnets can be used on whiteboards having a steel backing panel. Some whiteboards use tempered glass with a colored backing. Some whiteboards use polypropylene (PP) film or another polymeric film having appropriate surface characteristics for dry-erasing.

Dry-erase markers (also referred to as whiteboard markers herein) can be used on whiteboards for making temporary markings. Dry-erase markers can include dyes, pigments, and/or additives mixed with a solvent or other liquid media to produce an ink.

Aspects of the present disclosure are directed toward an improved dry-erase marker. First, some embodiments of the present disclosure result in a dry-erase marker able to write at various angles because of the customized surface topology of the marker head (e.g., depressions, microfibers, grooves, etc.) and/or the pressurized ink reservoir. Thus, embodiments of the present disclosure result in a dry-erase marker with improved usability.

Second, some embodiments of the present disclosure result in a dry-erase marker depositing a more consistent layer of ink because of the customized surface topology of the marker head (e.g., depressions, microfibers, and/or grooves). Thus, embodiments of the present disclosure result in a dry-erase marker that consistently transfers ink from the dry-erase marker to a whiteboard, resulting in improved markings made by the dry-erase marker.

Third, some embodiments of the present disclosure result in a dry-erase marker producing improved marking characteristics as a result of customized characteristics of the ink (e.g., shear-thickening, shear-thinning, and/or other non-Newtonian characteristics) together with the customized surface topology of the marker head. For example, some embodiments of the present disclosure can use a shear-thinning (e.g., dilatant) ink stored in the reservoir. A dilatant ink may be in a gel-like form while stored in the reservoir (e.g., because of low-shear stress applied to the ink in the reservoir), while the dilatant ink may subsequently thin into a liquid form appropriate for depositing on a whiteboard surface when a shear-stress is applied to the dilatant ink. Advantageously, the marker head can apply shear stress to the dilatant ink as a result of rotating (e.g., the interface between the rotating marker head and the ink reservoir) and/or as a result of the customized surface topology of the marker head.

The aforementioned advantages are example advantages, and embodiments of the present disclosure exist that can contain all, some, or none of the aforementioned advantages while remaining within the spirit and scope of the present disclosure.

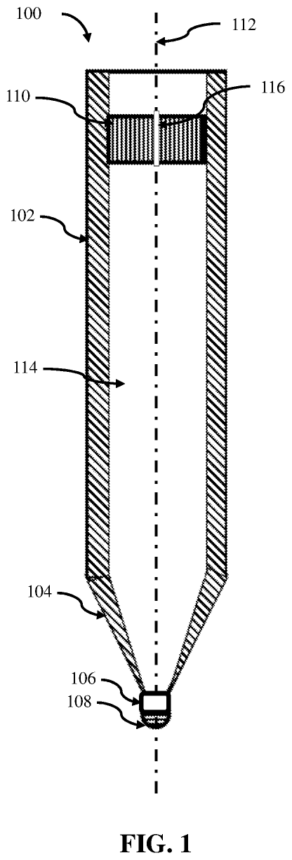

Referring now to the Figures, FIG. 1 illustrates a cross-sectional side-view of an example dry-erase marker 100, according to embodiments of the present disclosure. In some embodiments, dry-erase marker 100 includes a cylindrical housing 102, a conic housing 104, a socket 106, and a marker head 108. The cylindrical housing 102 can comprise an annulus configured to store ink in a hollow interior reservoir 114 of the cylindrical housing 102. The conic housing 104 can be affixed to, or of unitary construction with, the cylindrical housing 102. The conic housing 104 can be configured to transport ink from the reservoir 114 of the cylindrical housing 102 to the marker head 108 via the socket 106. In some embodiments, the cylindrical housing 102, conic housing 104, and socket 106 can be collectively referred to as a marker body. The marker head 108 can be affixed to the conic housing 104 by socket 106 such that the marker head 108 can rotate within the socket 106. Socket 106 can have geometric features appropriate to maintaining the marker head 108 attached to the dry-erase marker 100 while allowing marker head 108 to rotate. Rotating marker head 108 can transport ink from the interior of the conic housing 104 to a whiteboard exterior to the dry-erase marker 100.

For example, the socket 106 can include a spherical depression on an upper portion of socket 106 having a diameter larger than the diameter of the marker head 108 and configured to receive the marker head 108 in the spherical depression of the socket 106. In such embodiments, the socket 106 can also include a cylindrical lip on a lower portion of socket 106 and having a diameter less than the diameter of the marker head 108 and configured to hold the marker head 108 in the socket 106. In some embodiments, the height of socket 106 is greater than a radius of marker head 108 such that the socket 106 encompasses a majority of the marker head 108. In these embodiments, the portion of marker head 108 extending past the socket 106 can have a height less than the radius of the marker head 108.

In some embodiments, socket 106 can be made of a material more flexible than marker head 108 so that marker head 108 can be press-fit into socket 106. In some embodiments, socket 106 can be fabricated by additive manufacturing (e.g., three-dimensional printing) around an already existing marker head 108. In some embodiments, the socket 106 includes magnetized elements with controlled polarity that assist in keeping marker head 108 in socket 106.

In some embodiments, dry-erase marker 100 includes a plunger 110 configured to pressurize ink in the reservoir 114. Plunger 110 can include a gravity-based mechanism, a ratchet-based mechanism, or a different mechanism capable of adequately pressurizing the reservoir 114.

In embodiments including a gravity-based mechanism, the plunger 110 can be fabricated from a material of appropriate density to sufficiently pressurize the reservoir 114 as a result of the weight of plunger 110. In such embodiments, plunger 110 can be made from a metal or an alloy of two or more metals such as, but not limited to, steel, tungsten, carbide, nickel, copper, iron, etc. In some embodiments, the plunger 110 can be fabricated from a composite having a polymeric matrix material (e.g., a thermoplastic) and a dense particulate reinforcement material (e.g., a metal) capable of increasing the weight of the plunger 110 at a reduced cost relative to an all-metal plunger 110. In some embodiments, plunger 110 and the reservoir 114 of the cylindrical housing 102 and conic housing 104 are coated with an inert material configured to reduce reactivity between the ink stored in reservoir 114 and any of the components contacting the ink.

In embodiments where plunger 110 uses a ratchet-based technique to pressurize the reservoir 114, the plunger 110 can be associated with buttons, springs, clamps, and/or chucks capable of converting a temporary force (e.g., a user pushing a button on the dry-erase marker 100) into a permanent translation of plunger 110 toward the marker head 108.

Although not explicitly shown, plunger 110 can include a seal capable of isolating the ink in reservoir 114 from the atmosphere. The seal can be, but is not limited to, a mechanical gasket (e.g., an o-ring, a packing, a toric joint, etc.) stretch-fit into a groove in the plunger 110 (not shown) or over-molded onto the plunger 110 as a part of fabrication.

Although not explicitly shown, plunger 110 can also include a weep hole (e.g., a small-diameter hole extending through the thickness of the plunger 110 along a longitudinal axis 112) for evacuating air from the reservoir 114 while inserting the plunger 110 into the reservoir 114. In embodiments including a weep hole, the weep hole can be temporarily or permanently sealed after inserting the plunger 110 in to the reservoir 114 of the cylindrical housing 102.

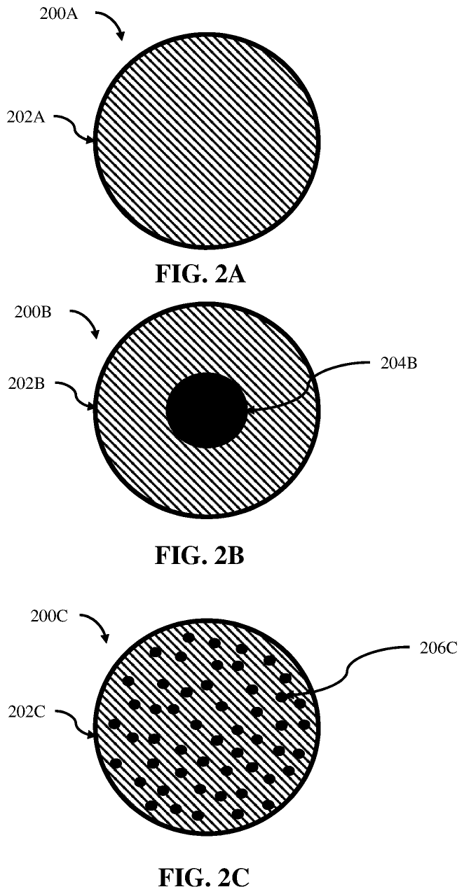

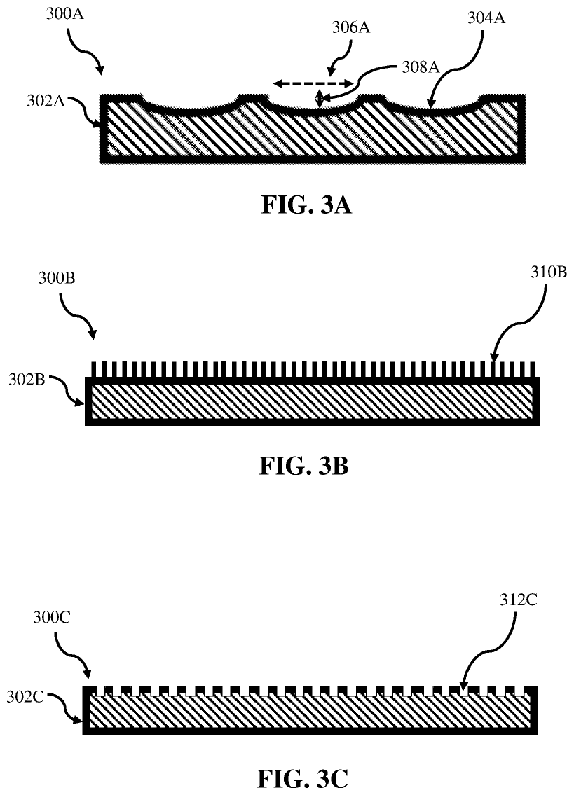

Marker head 108 is configured to receive ink from conic housing 104 and transfer the ink to a whiteboard by rotating in socket 106 while dry-erase marker 100 translates during writing. Marker head 108 includes beneficial materials and surface characteristics discussed in more detail hereinafter with respect to FIGS. 2A-2C and FIGS. 3A-3C.

Although dry-erase marker 100 is shown having symmetrical properties about a longitudinal axis 112, other embodiments include alternative configurations of components of dry-erase marker 100 that are not necessarily symmetrical about the longitudinal axis 112. Furthermore, embodiments exist with alternative geometries (e.g., rectangular) than the primarily cylindrical and/or annular geometries shown.

Interconnections between cylindrical housing 102, conic housing 104, and socket 106 are shown for representative purposes and other similar or dissimilar interconnections are possible. For example, two or more of cylindrical housing 102, conic housing 104, and socket 106 can be interconnected by bonding (e.g., adhesive bonding, over-molding, etc.), by mechanical fastening (e.g., threaded together, push-fit together, mechanically interlocked, etc.), or a different interconnection technique. Furthermore, in some embodiments, two or more of cylindrical housing 102, conic housing 104, and socket 106 can be of unitary construction such that they are fabricated together simultaneously (e.g., by three-dimensional printing, molding, etc.).

The dimensions, angles, orientations, configurations, and other interrelationships shown in FIG. 1 are not to be taken in a limiting sense, and are not meant to be construed as necessarily replicating, or even approximating, the dimensions, angles, orientations, configurations, and other possible interrelationships that may be realized in a dry-erase marker falling within the spirit and scope of the present disclosure.

Referring now to FIG. 2A, illustrated is a cross-sectional view of an example marker head 200A, in accordance with some embodiments of the present disclosure. In some embodiments, marker head 200A is consistent with marker head 108 of FIG. 1. Marker head 200A can include a spherical surface 202A including depressions, protrusions, microfibers, grooves, treads, or other characteristics described in more detail hereinafter with respect to FIGS. 3A-3C.

Marker head 200A can be made from one or more polymeric materials (e.g., thermoplastic, thermoplastic elastomer, thermoset, and/or elastomeric materials) as described in further detail hereinafter.

Referring now to FIG. 2B, illustrated is a cross-sectional view of an example magnetic marker head 200B. Magnetic marker head 200B includes a spherical surface 202B including depressions, protrusions, microfibers, grooves, treads, or other characteristics described in more detail hereinafter with respect to FIGS. 3A-3C. Magnetic marker head 202B further includes a magnet 204B. Magnet 204B can comprise a spherical magnet embedded within magnetic marker head 200B. Magnet 204B can be, but is not limited to, a permanent magnet fabricated from ferrite and/or alnico (e.g., a combination of aluminum, nickel, cobalt, copper, and/or titanium). In some embodiments, magnet 204B is fabricated into magnetic marker head 200B by additive manufacturing (e.g., three-dimensional printing), molding (e.g., over-molding, insert molding), or a different technique. In some embodiments, the magnet 204B has a diameter less than eight millimeters, less than five millimeters, or less than two millimeters.

Advantageously, embodiments including magnet 204B can exhibit improved usability when marking on a whiteboard having a steel backing panel because the magnetic marker head 200B can cause the dry-erase marker to be magnetically attracted to the whiteboard with a steel backing panel. In so doing, dry-erase markers having a magnetic marker head 200B can reduce mis-markings and/or improve the consistency of the deposited ink by having a constant force applied to the whiteboard as a result of the magnetic marker head 200B.

Referring now to FIG. 2C, illustrated is a cross-sectional view of an example composite marker head 200C. Composite marker head 200C includes a spherical surface 202C including depressions, protrusions, microfibers, grooves, treads, and/or other characteristics described in more detail hereinafter with respect to FIGS. 3A-3C. Composite marker head 202C further includes a plurality of particulates 206C. Particulates 206C can be, for example, magnetic particulates (e.g., similar to magnet 204B), metallic particulates (e.g., ferritic steel, iron, alloy, etc.), or a different type of particulate. Particulates 200C can be added to composite marker head 200C to tailor the properties (e.g., density, hardness, strength, magnetism, etc.) of the composite marker head 200C. The matrix phase of the composite marker head 200C (e.g., the portions of the composite marker head 200C excluding the plurality of particulates 206C) can be one or more polymeric materials (e.g., thermoplastics, thermoplastic elastomers, thermosets, and/or elastomers) as described in more detail hereinafter. Although the particulates 206C are shown as approximately spherical, particulates 206C can exhibit alternative geometries such as, but not limited to, short-fiber reinforcement and long-fiber reinforcement (described in further detail hereinafter). In some embodiments, the particulates 206C can be less than 0.1 millimeters in diameter.

FIGS. 2A-2C are not intended to replicate, or even necessarily approximate, the explicit or relative dimensions of any of the solid marker head 200A, magnetic marker head 200B, magnet 204B, composite marker head 200C, and/or particulates 206C. For example, in some embodiments, any of marker heads 200A-200C can be less than two centimeters in diameter, less than one centimeter in diameter, or a different dimension.

Each of the marker heads 200A-200C can include, at least in part, a polymeric material. Polymeric materials can include thermoplastics, thermoplastic elastomers, thermosets, and elastomers. Any of the polymeric materials can be reinforced by particulate reinforcements, short-fiber reinforcements, and/or long-fiber reinforcements. The reinforcements can include, but are not limited to, carbon fibers, aramid fibers, glass fibers, ceramic fibers, ceramic particulates, metallic fibers, and/or metallic particulates. Some reinforcement geometries can be characterized by an aspect ratio comprising a length of the reinforcement divided by a diameter of the reinforcement. For example, reinforcements can comprise particulates (e.g., aspect ratio less than 20), short fibers (e.g., aspect ratio between 20 and 200), long fibers (e.g., aspect ratio greater than 200), or different geometries. Furthermore, reinforcements can be characterized by a reinforcement volume fraction and/or a reinforcement weight fraction. Reinforcement volume fractions can be in the range of less than 30%, between 10%-70%, between 30%-50%, between 35%-45%, or greater than 60% according to various embodiments. Reinforcement weight fractions can be in the range of less than 30%, between 30%-90%, between 50%-70%, between 55%-65%, or greater than 70%, according to various embodiments.

A non-exhaustive list of thermoplastics includes, but is not limited to, polymethyl methacrylate (PMMA) (also referred to as acrylic), acrylonitrile butadiene styrene (ABS), polyamides (e.g., Nylon), polylactic acid (PLA), polybenzimidazole (PBI), polycarbonate (PC), polyether sulfone (PES), polyoxymethylene (POM), polyetherether ketone (PEEK), polyetherimide (PEI), polyethylene (PE) (including ultra-high-molecular weight polyethylene (UHMWPE), high-density polyethylene (HDPE), and low-density polyethylene (LDPE)), polyphenylene oxide (PPO), polyphenylene sulfide (PPS), polypropylene (PP), polystyrene (PS), polyvinyl chloride (PVC), and polytetrafluoroethylene (PTFE).

A non-exhaustive list of thermoplastic elastomers includes, but is not limited to, styrenic block copolymers (TPS or TPE-s), thermoplastic polyolefinelastomers (TPO, or TPE-o), thermoplastic vulcanizates (TPV or TPE-v), thermoplastic polyurethanes (TPU), thermoplastic copolyesters (TPC or TPE-E), and thermoplastic polyamides (TPA or TPE-A).

A non-exhaustive list of thermosets includes, but is not limited to, polyesters, polyurethanes, phenolics, melamines, epoxies, benzoxazines, polyimides, bismaleimides, cyanate esters, silicones, and vinyl esters.

A non-exhaustive list of elastomers includes, but is not limited to, polyisoprene, polybutadiene, chloroprene, styrene-butadiene, hydrogenated nitrile rubbers (HBR), ethylene propylene rubbers (EPM), epichlorohydrin rubbers (ECO), silicone rubbers, fluorosilicone rubbers (FVMQ), fluoroelastomers (FKM), perfluoroelastomers (FFKM), polyether block amides (PEBA), and ethylene-vinyl acetate (EVA).

Each of the marker heads 200A-200C can be fabricated by various methods such as, but not limited to, molding (e.g., compression molding, transfer molding, injection molding, over-molding, insert molding, rotational molding, etc.), additive manufacturing (e.g., three-dimensional printing, layer-by-layer deposition, fused deposition modeling (FDM), fused filament deposition, selective laser sintering, direct metal laser sintering, electron beam melting, stereolithography, and/or photopolymerization), or a different fabrication technique or combination of fabrication techniques.

Referring now to FIGS. 3A-3C which exhibit example surface topologies of marker heads of dry-erase markers, in accordance with embodiments of the present disclosure. FIGS. 3A-3C are not intended to replicate, or even necessarily approximate, the explicit or relative dimensions of any aspect of any of the surface topologies illustrated in FIGS. 3A-3C. Furthermore, although the surface topologies 302A-302C illustrated in FIGS. 3A-3C appear approximately linear, it should be appreciated that the surfaces 302A-302C are actually curvilinear in accordance with the curvature of the marker head of the dry-erase marker (e.g., as shown in FIGS. 2A-2C).

Referring now to FIG. 3A, illustrated is a cross-sectional exploded view of an example dimpled surface topology 300A of a marker head having a plurality of depressions 304A, according to embodiments of the present disclosure. In some embodiments, dimpled surface topology 300A can be a surface topology of a marker head in a dry-erase marker such as marker head 108 of FIG. 1. In some embodiments, dimpled surface topology 300A can be the surface topology of any of the surfaces 202A, 202B, and/or 202C of FIGS. 2A-2C.

Dimpled surface topology 300A can include a plurality of depressions 304A on a portion of a surface of a marker head 302A of a dry-erase marker. The plurality of depressions 304A can be spherical, elliptical, conical, cylindrical, square, rectangular, or a different geometry. In some embodiments, the plurality of depressions 304A are associated with a depth 308A less than one millimeter, and, in some embodiments, a depth 308A less than 0.1 millimeters. In some embodiments, the plurality of depressions 304A are associated with a diameter 306A of less than five millimeters, three millimeters, or one millimeter. In some embodiments, the plurality of depressions 304A can be geometrically characterized by a ratio of a diameter 306A of a depression to a depth 308A of a depression. In such cases, the ratio can be greater than a threshold (e.g., two, five, ten, twenty, etc.).

Depressions 304A can be fabricated concurrently with the fabrication of the marker head (e.g., during molding, where the depressions are formed by corresponding protrusions on a mold), or subsequently added. Subsequently added depressions can be formed by machining the depressions, by re-heating (e.g., above a glass transition temperature of the polymeric material) and imprinting the depressions, by impinging the depressions (e.g., sandblasting with a controlled grain size), or a different post-fabrication technique.

Referring now to FIG. 3B, illustrated is a cross-sectional exploded view of an example microfiber surface topology 300B of a marker head having a plurality of microfibers 310B, according to embodiments of the present disclosure. In some embodiments, microfiber surface topology 300B can be a surface topology of a marker head in a dry-erase marker such as marker head 108 of FIG. 1. In some embodiments, microfiber surface topology 300B can be the surface topology of any of the surfaces 202A, 202B, and/or 202C of FIGS. 2A-2C.

Microfiber surface topology 300B can include a plurality of microfibers 310B situated on a portion of a surface of a marker head 302B of a dry-erase marker. The plurality of microfibers 310B can be associated with various lengths, widths, spacings, and materials. For example, in some embodiments, respective microfibers of the plurality of microfibers 310B are less than one millimeter in length and less than 20 micrometers in diameter. In some embodiments, the plurality of microfibers 310B are characterized by an aspect ratio (e.g., length of a microfiber divided by a diameter of the microfiber), where the aspect ratio is greater than 10, greater than 20, or between 10-20. In some embodiments, respective microfibers of the plurality of microfibers 310B are spaced at an interval of less than 0.1 millimeters apart. In some embodiments, the plurality of microfibers 310B are natural fibers (e.g., jute fibers, hemp fibers, etc.), while in other embodiments the plurality of microfibers 310B are synthetic fibers (e.g., nylon fibers, acrylic fibers, olefin fibers, polyester fibers, aramid fibers, etc.). Microfibers 310B can be fabricated onto a marker head concurrently with molding or subsequently attached (e.g., adhesively bonded) post-molding.

Referring now to FIG. 3C, illustrated is a cross-sectional exploded view of an example grooved surface topology 300C of a marker head having a plurality of continuous grooves, according to embodiments of the present disclosure. In some embodiments, grooved surface topology 300C can be a surface topology of a marker head in a dry-erase marker such as marker head 108 of FIG. 1. In some embodiments, grooved surface topology 300C can be the surface topology of any of the surfaces 202A, 202B, and/or 202C of FIGS. 2A-2C.

Grooved surface topology 300C can include a plurality of grooves 312C etched into a portion of a surface of a marker head 302C of a dry-erase marker. The plurality of grooves 312C can be continuous grooves and/or discontinuous grooves having variable widths, depths, and/or cross-sectional geometries and arranged in various patterns to transfer ink from a reservoir of a dry-erase marker to a whiteboard at a desired consistency. In some embodiments, the grooves 312C have a depth of less than 0.5 millimeters, less than 0.1 millimeters, or a different dimension. In some embodiments, grooves 312C can have a width of less than 0.5 millimeters, less than 0.1 millimeters, or a different dimension. In some embodiments, a continuous groove of the plurality of grooves 312C can have a diameter less than a diameter of the marker head (e.g., continuous grooves need not be associated with a cross-sectional plane intersecting a center of the marker head).

Although rectangular grooves are illustrated in FIG. 3C, any number of alternative groove geometries are possible. For example, grooves 312C can have semi-circular cross-sectional profiles, elliptical cross-sectional profiles, triangular cross-sectional profiles, rectilinear cross-sectional profiles, or a different cross-sectional profile or combination of cross-sectional profiles.

Grooves 312C can be fabricated concurrently with molding of the marker head or subsequently etched by, for example, a machining process, a laser etching process, a re-heating (e.g., above a glass transition temperature) and imprinting process, or a different fabrication technique.

Each of the surface topologies 300A-300C illustrated in FIGS. 3A-3C can have customized dimensions, configurations, and characteristics suitable for applying a magnitude of shear stress to an ink in the dry-erase marker.

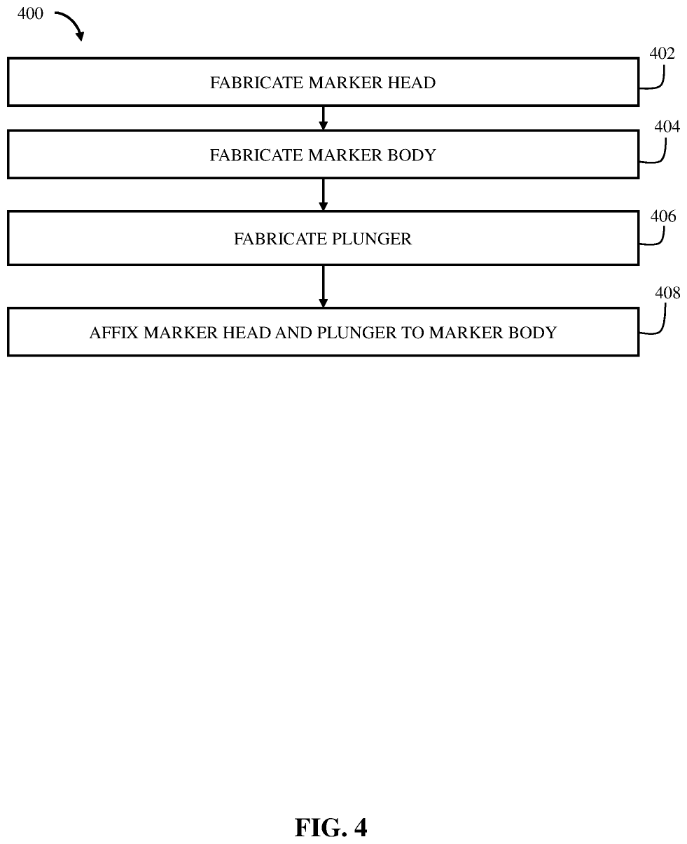

Referring now to FIG. 4, illustrated is a flowchart of an example method 400 for manufacturing a dry-erase marker, according to embodiments of the present disclosure. In some embodiments, the method 400 fabricates a dry-erase marker such as dry-erase marker 100 of FIG. 1 having a marker head such as any of the marker heads illustrated in FIGS. 2A-2C with a surface topology such as any of the surface topologies illustrated in FIGS. 3A-3C.

In operation 402, the marker head can be fabricated (e.g., marker head 108 of FIG. 1). The marker head can be fabricated to produce a marker head such as marker head 200A of FIG. 2A, a magnetic marker head such as magnetic marker head 200B of FIG. 2B, or a composite marker head such as composite marker head 200C of FIG. 2C. The marker head can be fabricated by molding (e.g., compression molding, transfer molding, injection molding, rotational molding, insert molding, over-molding, or a different molding method), additive manufacturing (e.g., three-dimensional printing, layer-by-layer deposition, fused deposition modeling (FDM), fused filament deposition, selective laser sintering, direct metal laser sintering, electron beam melting, stereolithography, and/or photopolymerization), or a different fabrication method or combination of fabrication methods.

In operation 404, the marker body can be fabricated (e.g., cylindrical housing 102, conic housing 104, and socket 106 of FIG. 1). The marker body can comprise a metal, an alloy, a polymer, a composite, a different material, or a combination of materials. The marker body can be fabricated by unitary construction or as a plurality of components (e.g., a separate cylindrical housing subsequently attached to a conic housing subsequently attached to a socket). The marker body can be fabricated by machining, casting, molding (e.g., as previously discussed), additive manufacturing (e.g., as previously discussed), forming (e.g., rolling and tack-welding a metal sheet template, rolling and ultrasonic-welding a polymeric sheet template, etc.), or a different method.

In operation 406, the plunger can be fabricated (e.g., plunger 110 of FIG. 1). The plunger can comprise one or more of a metallic material, an alloy material, a polymeric material, an elastomeric material, a composite material, or a different material. The plunger can be fabricated by machining, casting, molding (e.g., as previously discussed), additive manufacturing (e.g., as previously discussed), or a different method.

In operation 408, the marker head, plunger, and marker body can be affixed to one another. The marker head can be affixed to the socket of the marker body by, for example, push-fitting the marker head into the socket. The plunger can be affixed to the marker body by, for example, push-fitting the plunger into the reservoir of the marker body. In some embodiments, prior to affixing the plunger to the marker body, the marker body is filled with an ink. In embodiments where the marker body is filled with ink, the plunger can include a weep hole to allow air to escape from the reservoir during insertion of the plunger into the marker body. The weep hole can subsequently be sealed.

FIG. 4 is intended to illustrate the representative major operations of an example method for fabricating a dry-erase marker, according to embodiments of the present disclosure. However, the operations illustrated in FIG. 4 need not be performed sequentially and can be performed in alternative orders than the order shown in FIG. 4. Furthermore, embodiments can include additional operations than the operations shown in FIG. 4, where the additional operations can occur in addition to, or in substitution of, the operations shown in FIG. 4.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But, the various embodiments can be practiced without these specific details. In other instances, well-known structures and techniques have not been shown in detail in order not to obscure embodiments.

Different instances of the word “embodiment” as used within this specification do not necessarily refer to the same embodiment, but they can. Furthermore, different instances of numbers or numeric ranges discussed herein are provided for the purpose of example, and they are not to be taken in a limiting sense.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

1. A dry-erase marker comprising:
a cylindrical housing configured to store an ink;
a conic housing coupled to the cylindrical housing on a first end and having a socket on a second end;
a spherical marker head contained in the socket of the conic housing, wherein the spherical marker head comprises a polymeric material, wherein the spherical marker head comprises a plurality of circular depressions distributed about a surface of the spherical marker head;
a composite plunger in a reservoir of the cylindrical housing and configured to pressurize the ink in the cylindrical housing using a gravity-based mechanism, wherein the composite plunger comprises a thermoplastic matrix phase and a metal particulate reinforcement phase, wherein the composite plunger comprises a weep hole extending through the thickness of the composite plunger along a longitudinal axis of the composite plunger, and wherein the composite plunger is coated with an inert material that is configured to reduce reactivity between the ink and the composite plunger; and
wherein the conic housing is configured to transfer the ink from the cylindrical housing to the spherical marker head, and wherein the spherical marker head is configured to rotate in the socket in order to apply a shear force to the ink and transfer the ink to a dry-erase board that is in contact with the spherical marker head.

2. The dry-erase marker of claim 1, wherein a depression of the plurality of circular depressions comprises a depth of less than 0.1 millimeters and a diameter of less than one millimeter.

3. The dry-erase marker of claim 1, wherein a depression of the plurality of circular depressions has a diameter to depth ratio greater than five.

4. The dry-erase marker of claim 1, wherein a diameter of the spherical marker head is less than one centimeter.

5. The dry-erase marker of claim 1, wherein the spherical marker head further comprises a magnet embedded in the spherical marker head.

6. The dry-erase marker of claim 1, wherein the spherical marker head further comprises particulates of ferritic steel distributed throughout the spherical marker head.

7. (canceled)

8. A dry-erase marker comprising:
a cylindrical housing configured to store an ink;
a conic housing coupled to the cylindrical housing on a first end and having a socket on a second end;
a spherical marker head contained in the socket of the conic housing, wherein the spherical marker head comprises a polymeric material, wherein the spherical marker head comprises a plurality of microfibers distributed about a surface of the spherical marker head;
a composite plunger in a reservoir of the cylindrical housing and configured to pressurize the ink in the cylindrical housing using a gravity-based mechanism, wherein the composite plunger comprises a thermoplastic matrix phase and a metal particulate reinforcement phase, wherein the composite plunger comprises a weep hole extending through the thickness of the composite plunger along a longitudinal axis of the composite plunger, and wherein the composite plunger is coated with an inert material that is configured to reduce reactivity between the ink and the composite plunger; and
wherein the conic housing is configured to transfer the ink from the cylindrical housing to the spherical marker head, and wherein the spherical marker head is configured to rotate in the socket in order to apply a shear force to the ink and transfer the ink to a dry-erase board that is in contact with the spherical marker head.

9. The dry-erase marker of claim 8, wherein a microfiber of the plurality of microfibers comprises a diameter of less than 20 micrometers and a length of less than one millimeter.

10. The dry-erase marker of claim 8, wherein a microfiber of the plurality of microfibers has an aspect ratio of between 10-20 inclusive.

11. The dry-erase marker of claim 8, wherein a diameter of the spherical marker head is less than one centimeter.

12. The dry-erase marker of claim 8, wherein the spherical marker head further comprises a magnet embedded in the spherical marker head.

13. The dry-erase marker of claim 8, wherein the spherical marker head further comprises particulates of ferritic steel distributed throughout the spherical marker head.

14. (canceled)

15. A dry-erase marker comprising:
a cylindrical housing configured to store an ink;
a conic housing coupled to the cylindrical housing on a first end and having a socket on a second end;
a spherical marker head contained in the socket of the conic housing, wherein the spherical marker head comprises a polymeric material, wherein the spherical marker head comprises a plurality of continuous grooves distributed about a surface of the spherical marker head;
a composite plunger in a reservoir of the cylindrical housing and configured to pressurize the ink in the cylindrical housing using a gravity-based mechanism, wherein the composite plunger comprises a thermoplastic matrix phase and a metal particulate reinforcement phase, wherein the composite plunger comprises a weep hole extending through the thickness of the composite plunger along a longitudinal axis of the composite plunger, and wherein the composite plunger is coated with an inert material that is configured to reduce reactivity between the ink and the composite plunger; and
wherein the conic housing is configured to transfer the ink from the cylindrical housing to the spherical marker head, and wherein the spherical marker head is configured to rotate in the socket in order to apply a shear force to the ink and transfer the ink to a dry-erase board that is in contact with the spherical marker head.

16. The dry-erase marker of claim 15, wherein a groove of the plurality of continuous grooves comprises a width of less than 0.5 millimeters and a depth of less than 0.5 millimeters.

17. The dry-erase marker of claim 15, wherein a groove of the plurality of continuous grooves comprises a circle having a first diameter less than a second diameter of the spherical marker head.

18. The dry-erase marker of claim 15, wherein a diameter of the spherical marker head is less than one centimeter.

19. The dry-erase marker of claim 15, wherein the spherical marker head further comprises a magnet embedded in the spherical marker head.

20. The dry-erase marker of claim 15, wherein the spherical marker head further comprises particulates of ferritic steel distributed throughout the spherical marker head.

21. The dry-erase marker of claim 15, wherein the ink is a shear-thickening ink.

22. The dry-erase marker of claim 15, wherein the socket is fabricated by three-dimensional printing around the spherical marker head.
